(19) United States
(12) Patent Application Publication
(10) Pub. No.: US 2025/0306603 A1
(43) Pub. Date: Oct. 2, 2025

(54) A ROBOT AND A METHOD OF CONFIGURING AND OPERATING THE ROBOT

(71) Applicant: LIONSBOT INTERNATIONAL PTE LTD.,, Singapore (SG)

(72) Inventors: Sunardi TAY, Singapore (SG); Muhammad Khairul Syafiq BIN MOHD ZAINI, Singapore (SG); Sriharsha GHANTA, Singapore (SG); Mohan Rajesh ELARA, Singapore (SG); Terntzer Dylan NG, Singapore (SG)

(21) Appl. No.: 18/864,521

(22) PCT Filed: May 4, 2023
(86) PCT No.: PCT/SG2023/050302

§ 371 Date: Nov. 9, 2024

(30) Foreign Application Priority Data
May 9, 2022 (SG) 10202204825W

(51) Int. Cl. G05D 1/648; B25J 11/00

(52) U.S. Cl. CPC G05D 1/648; B25J 11/0085

(57) ABSTRACT

A robot having a processor is disclosed. The processor is configured to obtain a floor plan of an area, capture a first path in the area as the robot is guided by a user about the area, and display the captured first path on the floor plan on a display device. The processor is also configured to allow the user to modify the captured first path on the display device to obtain a desired first path and automatically move along the desired first path during operation. A method of operating a robot to clean an area and a method of deploying a robot to clean an area by a user are also disclosed.

### CROSS-REFERENCE TO RELATED APPLICATION

This application is a national stage application, filed under 35 U.S.C. § 371, of International Patent Application No. PCT/SG2023/050302, filed on May 4, 2023, which claims priority to Singapore Patent Application No. 1 10202204825 W filed with the Intellectual Property Office of Singapore on May 9, 2022, both of which are incorporated by reference herein in their entirety.

### TECHNICAL FIELD

This invention relates to a robot and a method of configuring and operating the robot. More particularly, this invention relates to a cleaning robot and a method of configuring the robot to define a cleaning path for the robot to follow during operation.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

FIG. 1 is a flowchart showing a sequence of steps in a method for configuring and operating a cleaning robot. The method includes a first step of creating a map or floor plan of an area in which the cleaning robot is to be deployed. The method further includes a second step of creating and editing the floor plan to include a cleaning path therein that the cleaning robot is to follow during operation. This step typically involves loading a copy of the floor plan and having a user manually edit the floor plan to add lines thereon indicating the cleaning path. The method further includes a third step of testing, wherein the cleaning robot is operated based on the entered cleaning path. Most times, the robot when following the cleaning path may run into obstacles which does not appear in the floor plan. The second and third steps are therefore repeated until a satisfactory cleaning path is obtained. Finally, the method includes a fourth step of deploying the cleaning robot to execute the cleaning operation along the cleaning path. The above-described method of configuring and operating a cleaning robot in a new location is laborious and time consuming.

To mitigate this problem, different solutions have been proposed. Some of these solutions are disclosed in U.S. Pat. Nos. 10,717,191B2, 9,630,318B2, 9,364,950B2, and 9,950,426B2.

There is therefore a need for a robot deployment system and method which addresses, at least in part, one or more of the forgoing problems.

### SUMMARY

According to an aspect of the present disclosure, there is provided a robot having a processor. The processor is configured to obtain a floor plan of an area, capture a first path in the area as the robot is guided by a user about the area, and display the captured first path on the floor plan on a display device. The processor is also configured to allow the user to modify the captured first path on the display device to obtain a desired first path and automatically move along the desired first path during operation.

In some embodiments of the robot, the first path defines a perimeter of a cleaning zone within the area. And the processor is further configured to generate a second path within the cleaning zone and automatically move along the second path during operation.

In some embodiments of the robot, the processor is configured to determine if a rectangle can be defined within the cleaning zone and obtain a pattern path for the rectangle and a spiral path around the rectangle that together define the second path if it is determined that a rectangle can be defined within the cleaning zone.

In some embodiments of the robot, the processor is configured to increasingly reduce a size of the cleaning zone, each time by a cleaning width of the robot to obtain a current smaller cleaning zone until the robot determines one of a rectangle and minimum rotated rectangle bounding the current smaller cleaning zone fits within the cleaning zone or no further smaller cleaning zone can be obtained.

In some embodiments of the robot, the processor is configured to generate a candidate pattern path from each side of the rectangle to obtain a plurality of candidate pattern paths in the rectangle and generate a plurality of candidate spiral paths. The processor is also configured to determine a cleaning cost for each combination of each of the plurality of candidate pattern paths and each of the plurality of candidate spiral paths and select a combination of candidate pattern path and candidate spiral path with a lowest cleaning cost as the second path.

In some embodiments of the robot, the processor is configured to provide points along the captured first path which can be moved to modify the captured first path.

In some embodiments of the robot the processor is configured to allow the points to be dragged and dropped to modify the captured first path.

In some embodiments of the robot, the processor is configured to obtain the floor plan of the area and capture the first path at the same time.

In some embodiments of the robot, the robot further includes a Lidar scanner. And the processor is configured to obtain the floor plan of the area using the Lidar scanner.

According to another aspect of the present disclosure, there is provided a method of operating a robot to clean an area. The method includes obtaining a floor plan of the area, capturing a first path in the area as the robot is guided by a user about the area, and displaying the captured first path on the floor plan. The method further includes allowing the user to modify the captured first path to obtain a desired first path; and allowing the robot to be operated to automatically move along the desired path to clean the area.

In some embodiments of the method, the path defines a perimeter of a cleaning zone within the area, and the method further includes automatically generating a second path within the cleaning zone and allowing the robot to be operated to clean the area along the second path while automatically moving therealong.

In some embodiments of the method, automatically generating a second path within the cleaning zone includes determining if a rectangle can be defined within the cleaning zone and obtaining a pattern path for the rectangle and a spiral path around the rectangle that together define the second path if it is determined that a rectangle can be defined within the cleaning zone.

In some embodiments of the method, determining if a rectangle can be defined within the cleaning zone includes increasingly reducing a size of the cleaning zone, each time by a cleaning width of the robot to obtain a current smaller cleaning zone until it is determined that one of a rectangle and minimum rotated rectangle bounding the current smaller cleaning zone fits within the cleaning zone or no further smaller cleaning zone can be obtained.

In some embodiments of the method, obtaining a pattern path for the rectangle and a spiral path around the rectangle that together define the second path includes generating a candidate pattern path from each side of the rectangle to define a plurality of candidate pattern paths in the rectangle, generating a plurality of candidate spiral paths, determining a cleaning cost for each combination of each of the plurality of candidate pattern paths and each of the plurality of candidate spiral paths, and selecting a combination of candidate pattern path and candidate spiral path with a lowest cleaning cost as the second path.

In some embodiments of the method, allowing the user to modify the captured first path includes providing points along the captured first path which can be moved to modify the captured first path.

In some embodiments of the method, providing points along the captured first path which can be moved to modify the captured first path includes providing the points along the path which can be dragged and dropped to modify the captured first path.

In some embodiments of the method, obtaining the floor plan of the area is performed at the same time as capturing the first path.

According to yet another aspect of the present disclosure, there is provided a method of deploying a robot to clean an area by a user. The method includes guiding the robot about the area to allow the robot to capture a first path in the area as the robot is guided by a user about the area, modifying the captured first path to obtain a desired first path via a display, and deploying the robot to automatically move along the desired first path to clean the area.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is a flowchart showing a typical sequence of steps for configuring and operating a cleaning robot; is a flowchart showing a sequence of steps for configuring and operating a cleaning robot according to an embodiment of the invention;

FIG. 3A is a MAIN MENU screen on a display device of the robot in FIG. 2, the MAIN MENU screen including a JUST CLEAN button;

FIG. 3B is a JUST CLEAN screen on the display device of the robot in FIG. 2 when the JUST CLEAN button in FIG. 3A is actuated, the JUST CLEAN screen including a PERIMETER MODE button and a GUIDE & CLEAN button;

FIG. 3C is a PATH CAPTURE screen on the display device of the robot in FIG. 2 when the PERIMETER MODE button in FIG. 3B is actuated, the PATH CAPTURE screen including a SAVE MAP button and a partially captured path;

FIG. 3D is the PATH CAPTURE screen in FIG. 2 showing a complete captured path;

FIG. 3E is a SAVING MAP screen on the display device of the robot in FIG. 2 when the SAVE MAP button in FIG. 3C;

FIG. 3F is an EDIT MAP screen on the display device of the robot in FIG. 2 after the captured path has been saved, showing a cleaning zone defined by the captured path and an automatically generated cleaning path within the cleaning zone and a START CLEAN button;

FIG. 3G is a CLEANING IN PROGRESS screen on the display device of the robot in FIG. 2 when the START CLEAN button in FIG. 3F is actuated, showing where the robot is along the cleaning path during a cleaning operation;

FIG. 4A is the JUST CLEAN screen in FIG. 3B, showing the selection of the GUIDE & CLEAN button thereon;

FIG. 4B is a PATH CAPTURE screen on the display device of the robot in FIG. 2 when the GUIDE & CLEAN button in FIG. 4A is actuated, the PATH CAPTURE screen including a SAVE MAP button and a partially captured path;

FIG. 4C is an EDIT MAP screen on the display device of the robot in FIG. 2 after the captured path in FIG. 4B has been saved, showing the captured path as a cleaning path and a START CLEAN button;

FIG. 4D is a CLEANING IN PROGRESS screen on the display device of the robot in FIG. 2 when the START CLEAN button in FIG. 4C is actuated, showing where the robot is along the cleaning path during a cleaning operation;

FIG. 5A is a floor plan of an area to be cleaned;

FIG. 5B is the floor plan in FIG. 5A showing a zone that is carpeted; FIG. 5C is the floor plan in FIG. 5A showing a cleaning zone that is to be scrubbed using the robot;

FIG. 5D is the floor plan in FIG. 5C showing an automatically generated cleaning path within the cleaning zone;

FIG. 6A is a floor plan of another area to be cleaned;

FIG. 6B is the floor plan in FIG. 6A showing two cleaning zones;

FIG. 6C is the floor plan in FIG. 6B showing an automatically generated cleaning path within each of the two cleaning zones;

FIG. 7 is a flowchart showing a sequence of steps for automatically generating the cleaning paths in FIG. 5D and FIG. 6C;

FIG. 8 is a drawing showing a cleaning zone and a method of determining if a rectangle fits within the cleaning zone in one of the steps in FIG. 7;

FIG. 9 is a drawing showing a cleaning zone which is a concave polygon in within which no rectangle will fit according to the method in FIG. 8;

FIG. 10 is a drawing showing a rectangle and an automatically generated patten path therein that defines a cleaning path; and

FIG. 11 is a block diagram illustrating typical elements of a controller card of the robot that may be appropriately programmed to perform the methods in FIG. 2, FIG. 7 and FIG. 8.

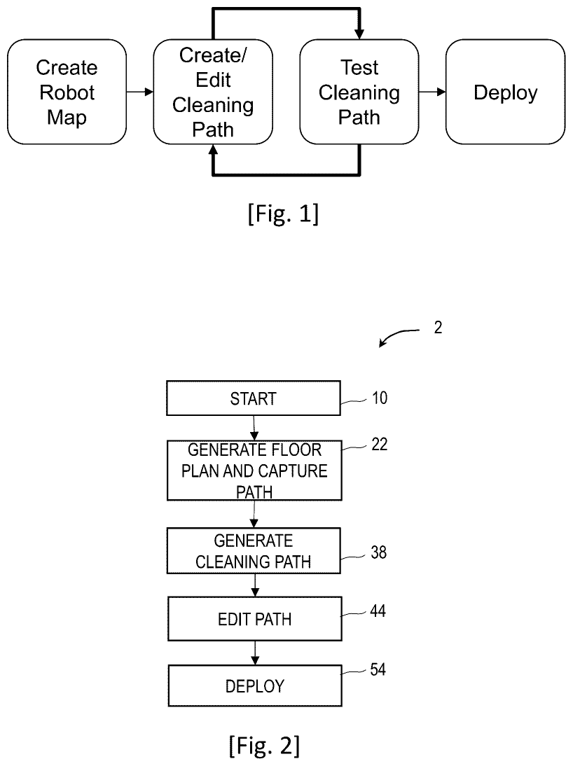

### DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Throughout the description, it is to be appreciated that the term ‘processor/controller’ and its plural form include microcontrollers, microprocessors, programmable integrated circuit chips such as application specific integrated circuit chip (ASIC), computer servers, electronic devices, and/or combination thereof capable of processing one or more input electronic signals to produce one or more output electronic signals. The controller includes one or more input modules and one or more output modules for processing of electronic signals.

Unless defined otherwise, all technical and scientific terms used herein have the same meaning as is commonly understood by a skilled person to which the subject matter herein belongs.

As shown in the drawings for purposes of illustration, the invention may be embodied in a less labour intensive and quicker method of configuring and operating a cleaning robot to clean an area. Existing methods tend to be laborious and time-consuming. Referring to FIG. 2, the method generally includes obtaining a floor plan of the area, capturing a first path in the area as the robot is guided by a user about the area, and displaying the captured first path on the floor plan. The method further includes allowing the user to modify the captured first path to obtain a desired first path and allowing the robot to be operated to automatically move along the desired path to clean the area.

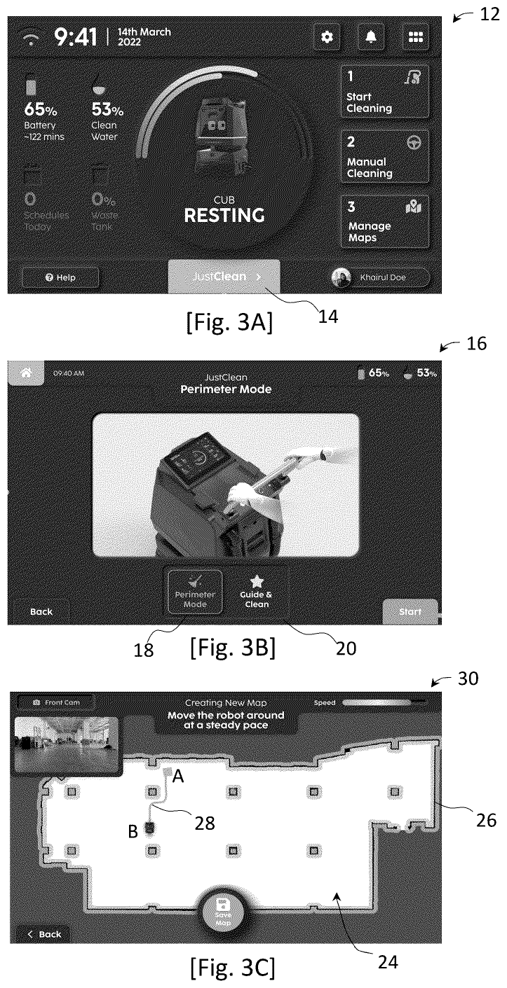

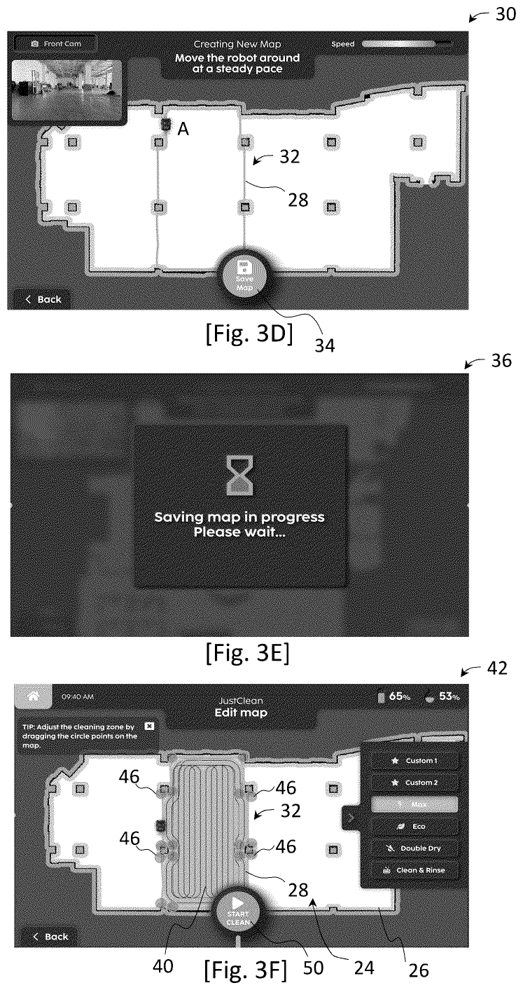

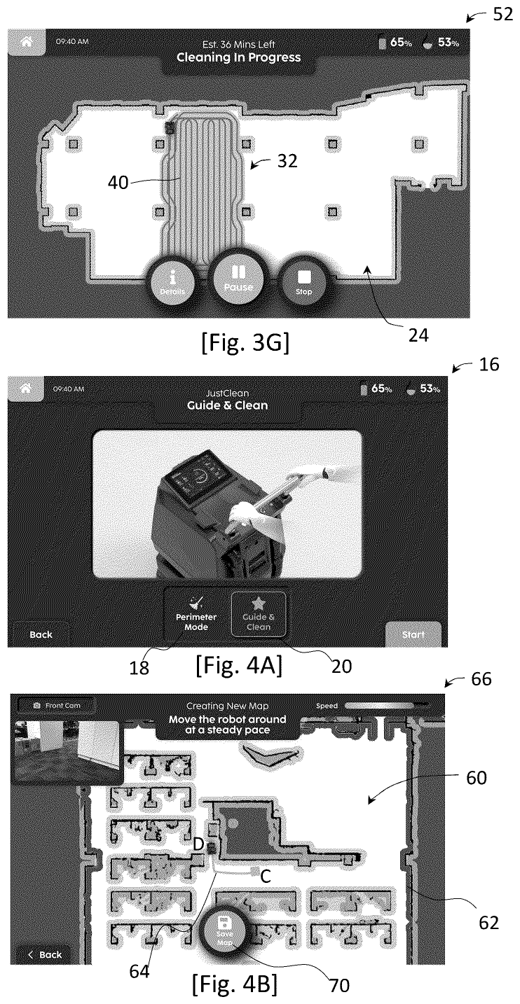

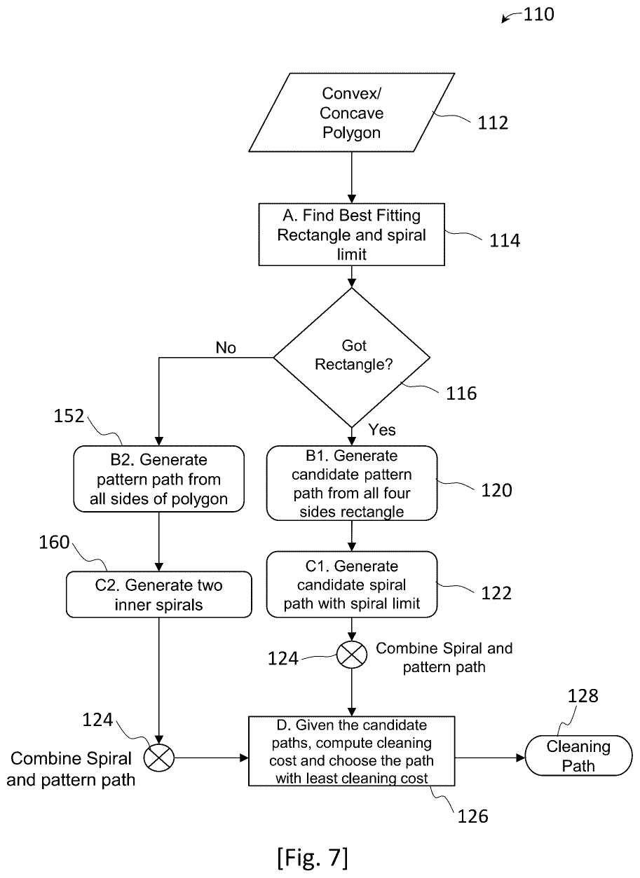

Specifically, FIG. 2 is a flowchart 2 showing a sequence of steps in a method for configuring and operating a robot (not shown) according to an embodiment of the invention. The robot includes a controller board 4 (FIG. 11) for controlling the operations of the robot. The controller board 4 includes a processor 6. The robot also includes a touch-screen display 206 that is controlled by the processor 6. The sequence 2 starts in a START step 10, wherein the robot displays a main menu 12 on the display. An example of the main menu 12 is shown in FIG. 3A. The main menu 12 includes a JUST CLEAN button 14. When the JUST CLEAN button 14 is actuated, the robot displays a JUST CLEAN menu 16 that is shown in FIG. 3B. The JUST CLEAN menu 16 includes a PERIMETER MODE button 18 and a GUIDE & CLEAN button 20. When the PERIMETER MODE button 18 is actuated, the robot enters a PERIMETER mode and the sequence 2 proceeds to a GENERATE FLOOR PLAN AND CAPTURE PATH step 22, wherein the robot is guided by a user in an area 24 to be cleaned to generate a floor plan 26 of the area 24 and at the same time capture a first path 28 traversed by the guided robot. In this step 22, the robot displays on the display a PATH CAPTURE screen 30 as shown in FIG. 3C. In FIG. 3C, a complete floor plan 26 of the area 24 is shown. However, in other embodiments, only a partial floor plan may be shown and updated as and when information is captured and made available. The floor plan 26 may be generated, for example, using a 2D Lidar scanner (not shown) mounted on the robot. FIG. 3C shows the first path 28 of the robot after it has been guided from a starting position A to a current position B. As the robot is wheeled around, the floor plan 26 gets updated and the first path 28 traversed by the robot is also updated on the display. FIG. 3D shows an updated PATH CAPTURE screen 30 when the robot is back at the starting point A having been wheeled one round to define a cleaning zone 32. The first path 28 taken by the robot defines a perimeter of the cleaning zone 32. The cleaning zone may take on any shape, for example, a convex polygon or a concave polygon. At this point, the user can actuate a SAVE MAP button 34 on the PATH CAPTURE screen 30 to save the floor plan 26 in a memory of the controller board 4. When the SAVE MAP button 34 is actuated, the robot displays a SAVING MAP screen 36 as shown in FIG. 3E. If the robot is not wheeled back to the starting point A, the processor 6 in this PERIMETER mode automatically joins the last position of the robot when the SAVE MAP button 34 is actuated to the starting position A to complete the cleaning zone 32. At this stage, the sequence 2 next proceeds to a GENERATE CLEANING PATH step 38, wherein the robot automatically generates a cleaning path 40, i.e. a second path, within the cleaning zone 32. The details of how this cleaning path 40 within the cleaning zone 32 is generated will be described later with the aid of FIG. 7. Such a cleaning path 40 may be one that ensures maximum area coverage, and/or most efficient in time and cleaning behavior of the robot.

When the cleaning path 40 within the cleaning zone 32 is generated, the robot displays an EDIT MAP screen 42 as shown in FIG. 3F. At this point, the sequence 2 proceeds to an EDIT PATH step 44 wherein the user is allowed to edit the captured first path 28. The EDIT MAP screen 42 includes the cleaning zone 32 and the automatically generated cleaning path 40 within the cleaning zone 32. Points 46 are also included in the perimeter 28 of the cleaning zone 32 that can be individually dragged and dropped to change the boundary of the cleaning zone 32. Although points 46 are shown only at corners of the cleaning zone 32 in FIG. 3F, points (not shown) may be included along any of the edges of the cleaning zone 32. When the cleaning zone 32 is changed as a result of a point 46 being dragged and dropped at a different position on the EDIT MAP screen 42 by the user, a new cleaning path 40 within the modified cleaning zone 32 will be generated. These changes will be reflected on the EDIT MAP screen 42. This method allows the user to easily customize and control where in the area 24 the robot is to clean. Deployment of a robot is therefore less laborious and time consuming. The EDIT MAP screen 42 includes a START CLEAN button 50. When this START CLEAN button 50 is actuated, the robot displays a CLEANING IN PROGRESS screen 52 as shown in FIG. 3G. At this point, the sequence proceeds to a DEPLOY step 54, wherein the robot enters a cleaning operation mode to clean the cleaning zone 32 in the area 24 by following the generated cleaning path 40. The robot may or may not clean along the captured first path 28.

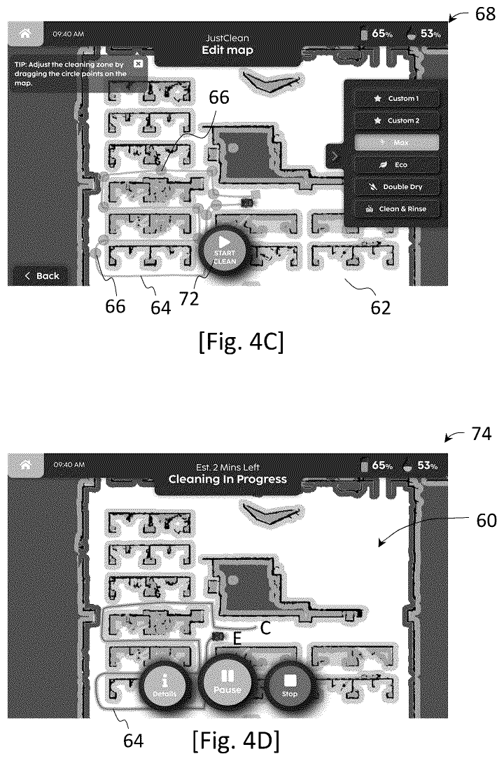

According to another embodiment, when the GUIDE & CLEAN button 20 in the JUST CLEAN screen 16 in FIG. 3B is actuated as shown in FIG. 4A, the robot enters a GUIDE & CLEAN mode and the sequence 2 proceeds from the START step 10 to the GENERATE FLOOR PLAN AND CAPTURE PATH step 22 as previously described, wherein the robot is guided by the user in an area 60 to be cleaned to generate a floor plan 62 of the area 60 and at the same time capture a path 64, similar to the first path 28 in FIG. 3C, traversed by the guided robot. In this step 22, the robot displays on the display a PATH CAPTURE screen 66 as shown in FIG. 4B. In FIG. 4B, a partial floor plan 62 of the area 60 is shown. FIG. 4B shows the path 64 of the robot having been guided from a starting position C to a current position D. As the robot is wheeled around, the floor plan 62 and the path 64 traversed by the robot are updated. The updated path 64 when the robot is wheeled to a final position E close to the starting point C is shown in an EDIT MAP screen 68 in FIG. 4C. Unlike the embodiment described above in relation to the PERIMETER mode where the path 28 taken by the robot defines the perimeter of a cleaning zone 32, the path 64 taken by the robot in this GUIDE & CLEAN mode merely defines the exact cleaning path 64 to be taken by the robot during a cleaning operation. The user can actuate a SAVE MAP button 70 on the PATH CAPTURE screen 66 to save the floor plan 62 and the captured path 64. When the SAVE MAP button 70 is actuated, the robot displays a SAVING MAP screen 36 shown in FIG. 3E before displaying the EDIT MAP screen 68 described above. Unlike the earlier embodiment in the PERIMETER mode, the final position E is not joined to the position A to define a cleaning zone 32 and, as such, no further cleaning path 40 is generated and the GENERATE CLEANING PATH step 38 in the sequence 2 is skipped. The path 64 traversed by the robot in the GENERATE FLOOR PLAN AND CAPTURE PATH step 22 will in this GUIDE & CLEAN mode be the cleaning path 64.

When the EDIT MAP screen 68 is displayed, the sequence 2 proceeds to the EDIT PATH step 44. The EDIT MAP screen 68 includes the cleaning path 64 and points 66 are included along the cleaning path 64 that can be individually dragged and dropped to change the cleaning path 64 itself. Although points 66 are shown only at corners of the cleaning path 64, points may be included anywhere along the entire length of the cleaning path 64. The user may also add or remove points along the cleaning path 64 to aid in modifying it. Any change to the cleaning path 64 will be reflected on the EDIT MAP screen 68. Using such a method, the user can again easily adjust the cleaning path 64 making configuring and operating a robot less laborious and time consuming. The EDIT MAP screen 68 includes a START CLEAN button 72. When this START CLEAN button 72 is actuated, the robot displays a CLEANING IN PROGRESS screen 74 as shown in FIG. 4D. At this point, the sequence proceeds to the DEPLOY step 54, where the robot is deployed to clean the area 60 by moving along the cleaning path 64.

Although it is described above in the PERIMETER mode that the floor plan 26 is generated at the same time as capturing the path 28, it is not to be construed to be limited as such. For example, an existing map or floor plan may also be used in the PERIMETER mode. The robot can still be wheeled around the area 24 to be cleaned to capture the path 28 as before to define a cleaning zone 32.

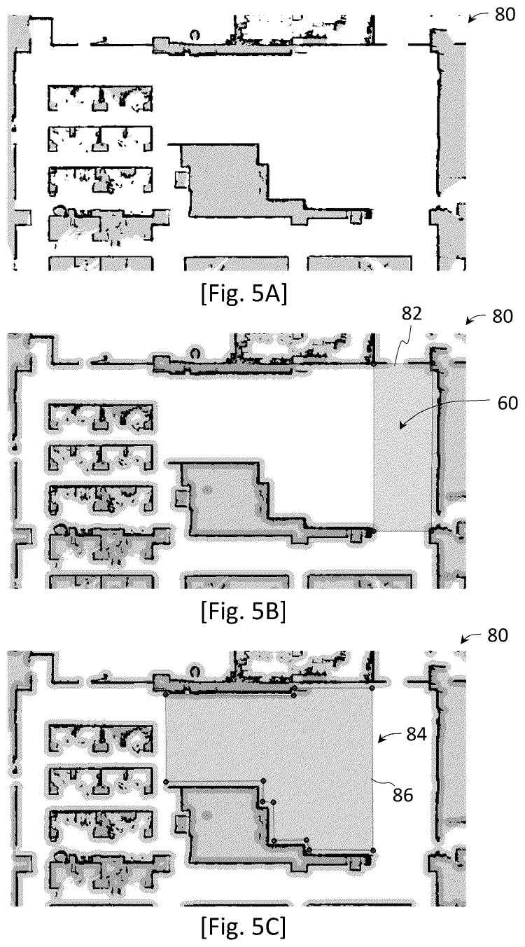

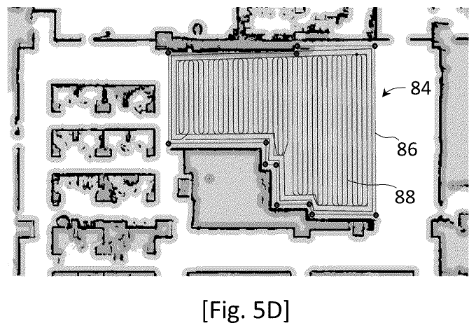

The floor plan 32 is typically constructed using images captured using a 2D Lidar scanner as is known to those skilled in the art. FIG. 5A shows a floor plan 80 of an area that is captured using the 2D Lidar scanner. Such a floor plan 80 includes only structural details like partitions, pillars, etc. without providing information relating to flooring types and coverings. For example, the floor may include a carpeted zone 82 shown only in FIG. 5B for illustration but not visible in the actual floor plan 80. A user editing the floor plan 80 to include a floor scrubbing zone will not be able to tell the exact boundary of the carpeted zone 82 and an adjacent non-carpeted zone. Editing the floor plan 80 without being able to see the carpeted zone 82 thereon to include a cleaning zone 84 to scrub the non-carpeted zone will thus be a hit-and-miss effort. The process of accurately defining the cleaning zone 84 will be laborious and time consuming requiring multiple iterations before arriving at a satisfactory cleaning zone 84.

With the method described earlier, the robot can be easily guided in the actual area along a path 86 to map out the cleaning zone 84 for scrubbing as the user guiding the robot is able to see and avoid encroaching on the carpeted zone 82. In this manner, defining the cleaning zone 84 will no longer be a hit-and-miss effort. The user can easily wheel the robot close to but not encroaching the carpeted zone 82 to accurately define the cleaning zone 84 in a CAPTURE PATH step (not shown) that replaces the GENERATE MAP AND CAPTURE PATH step 22 in FIG. 2. Only a single pass may be required to accurately map the cleaning zone 84. After the cleaning zone 84 is defined, the user may be allowed, as described earlier, to edit the cleaning path 86 to redefine the cleaning zone 84 in the EDIT PATH step 44. As the mapped path 86 is edited to redefine the cleaning zone 84, a cleaning path 88 (FIG. 5D) within the cleaning zone 84 can be automatically generated as described earlier.

Similarly, an existing floor plan may be used in the GUIDE and CLEAN mode described above. The robot may be guided in the area and its path 64 captured and displayed on the floor plan 62 as described above. The user will also be able to edit this path 64 on the display.

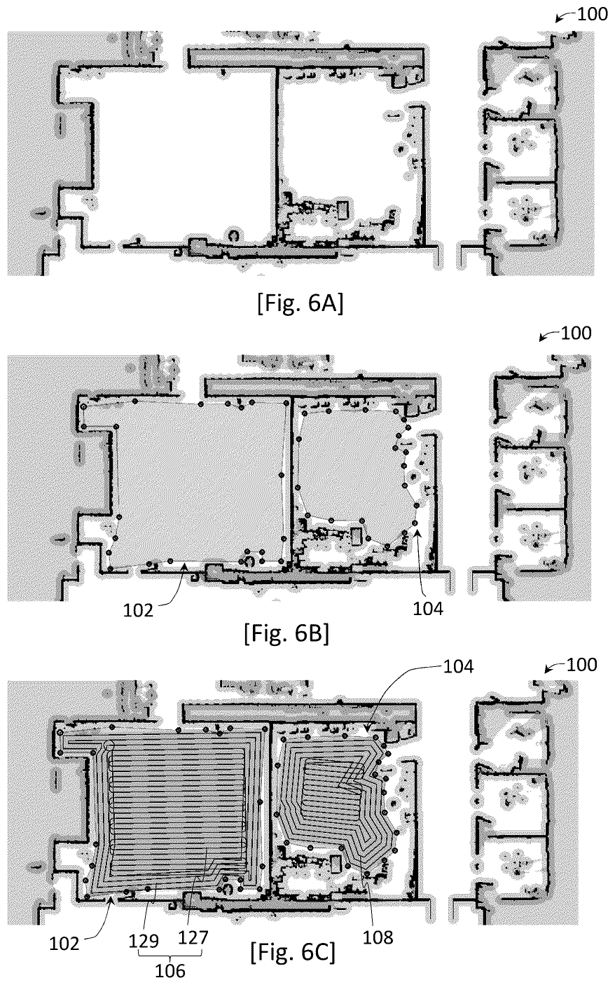

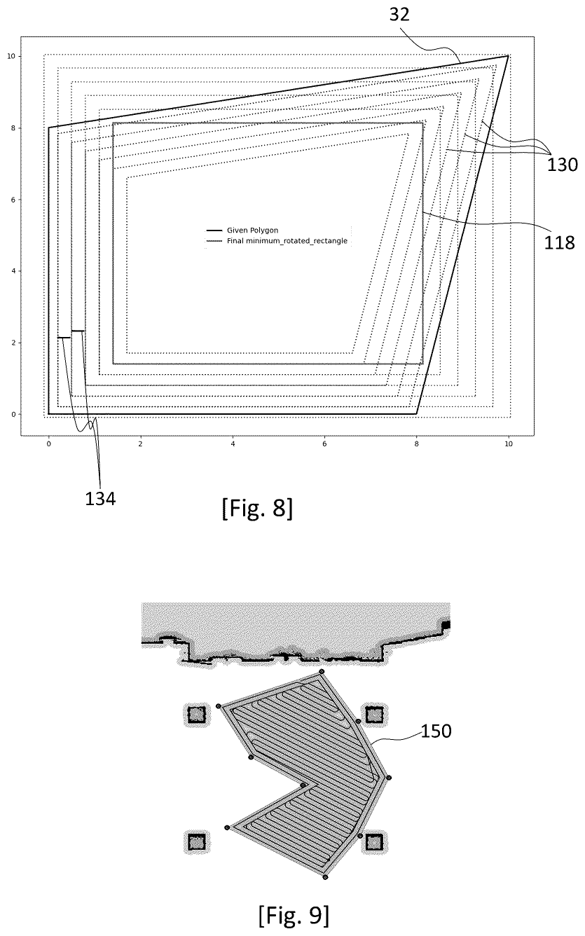

Next, the method of generating a cleaning path in a cleaning zone in the GENERATE CLEANING PATH step 38 is described. FIG. 6A shows a floor plan 100 and FIG. 6B shows two cleaning zones 102, 104 defined on the floor plan 100. FIG. 6C shows a generated cleaning path 106, 108 in each of the two cleaning zones 102, 104. FIG. 7 shows a sequence 110 of steps in the method for generating the cleaning path 40 (FIG. 3F) in a cleaning zone 32. The sequence 110 starts in a START step 112 when the SAVE MAP button 34 is actuated in the PATH CAPTURE screen 30. The cleaning zone 32 described earlier may be a convex polygon or a concave polygon. The sequence 110 then proceeds to a FIND FITTING RECTANGLE step 114, wherein the processor 6 determines if a suitable rectangle can be defined in the polygon 32. This FIND FITTING RECTANGLE step will be described in more details later. The sequence 110 next proceeds to a GOT RECTANGLE? decision step 116, wherein the processor 6 determines if a suitable rectangle can be defined in the polygon 32. If it is determined in this decision step 116 that a rectangle 118 (FIG. 8) can be defined in the polygon 32, the sequence 110 proceeds to a GENERATE CANDIDATE PATTERN PATH step 120 wherein the processor 6 generates a candidate pattern path from each of the four sides of the rectangle 118. Each candidate pattern path will be multiple parallel lines. This GENERATE CANDIDATE PATTERN PATH step 120 will be described later. The sequence 110 next proceeds to a GENERATE CANDIDATE SPIRAL PATH step 122 wherein the processor 6 generates a number of candidate spiral paths with the number of spirals according to a spiral limit determined in the FIND FITTING RECTANGLE step 114. The sequence 110 next proceeds to a COMBINE step 124, wherein each candidate pattern path is combined with each candidate spiral path to produce different combinations of candidate pattern path and candidate spiral path. The sequence 110 then proceeds to a SELECT PATH step 126 wherein the processor 6 computes a cleaning cost for each combination of candidate pattern path and candidate spiral path, and selects the combination with a lowest cleaning cost as the cleaning path 40. The sequence 110 ends in an END step 128 wherein the processor displays the selected cleaning path 40 on the floor plan 26 as shown in FIG. 3F and FIG. 6C. For example, in FIG. 6C, the cleaning path 106 will include a pattern path 127 and a spiral path 129.

The FIND FITTING RECTANGLE step 114 will be described in more details with the aid of FIG. 8 and the pseudo code below. With a given polygon 32 as shown in FIG. 8, a geometrical approximation method known to those skilled in the art as “buffer” is used to generate an increasingly smaller polygon 130 inside the given polygon 32 with a gap 134 of a cleaning distance or cleaning width of the robot until a suitable rectangle 118 is found to fit within the given polygon 32. This buffer calculation is carried out repeatedly until either a minimum rotated rectangle or a bounding box 118 of a generated smaller polygon 130 lies within the given polygon 32. The number of times a generated polygon 130 is reduced in size until the rectangle 118 is found will determine a number of spirals or spiral limit (given by slimit in the pseudo code below) that are required to be taken in the GENERATE CANDIDATE SPIRAL PATH step 122 in generating the candidate spiral paths. The minimum rotated rectangle or bounding box 118 of the last buffer calculation is used to compute the pattern path in the GENERATE CANDIDATE PATTERN PATH step 120 based on the cleaning width (w) and a turning radius (r) of the robot.

### Pseudocode:

```
INPUT polygon(p), turning_radius(r),
cleaning_width(w), robot_width(wᵣ)
$SET {p}_{temp} to p . buffer ( - \frac{{w}_{r}}{2} )$
SET c to 1
SET sₗᵢₘᵢₜ
WHILE True:
  SET _buffᵥₐₗᵤₑ to r + (c * w)
  SET pₜₑₘₚ = p_{temp.}buffer(−buffᵥₐₗᵤₑ)
  IF empty (pₜₑₘₚ) THEN
    BREAK
  ELSE
    INCREMENT c
  ENDIF
  SET rect to minimum_rotated_rectangle(pₜₑₘₚ)
  SET bound to envelope (pₜₑₘₚ)
  IF rect.within(p) or bound.within(p) THEN
    SET sₗᵢₘᵢₜ
    BREAK
  ENDIF
ENDWHILE
```

### Terminology

a. within—returns true if the called object is inside the given object
b. buffer (distance)—a geometrical approximation method that provides a polygon approximated at the given distance
c. minimum_rotated_rectangle (polygon)—general minimum bounding rectangle that contains the polygon which is not constrained to be parallel to the X and Y coordinate axes.
d. Envelope (polygon)—general bounding rectangle that contains the polygon which is constrained to be parallel to the X and Y coordinate axes.

If it is determined in the GOT RECTANGLE? decision step 116 that no rectangle fits in a given polygon, e.g. a polygon 150 shown in FIG. 9, the sequence 110 proceeds to a GENERATE PATTERN PATH step 152 wherein the processor 6 generates parallel lines from each of the sides of the given polygon 150.

[The parallel lines in the GENERATE PATTERN PATH step 152 and the GENERATE CANDIDATE PATTERN PATH step 120 are then sorted and split based on the cleaning width (w) and the turning radius (r) of the robot. The parallel lines set is split into multiple sets based on the required lines.

$${l}_{min} = ceil ( 2 * \frac{r}{w} )$$

$${l}_{req} = 2 * ( {l}_{min} )$$

Where
lₘᵢₙ is minimum number of line gaps between two lines in a pattern path,
l_{reg} is the required number of lines to get complete pattern path,
ceil rounds upward returning the smallest integral value that is not less than the
given value,
r is the turning radius and
w is the cleaning width.

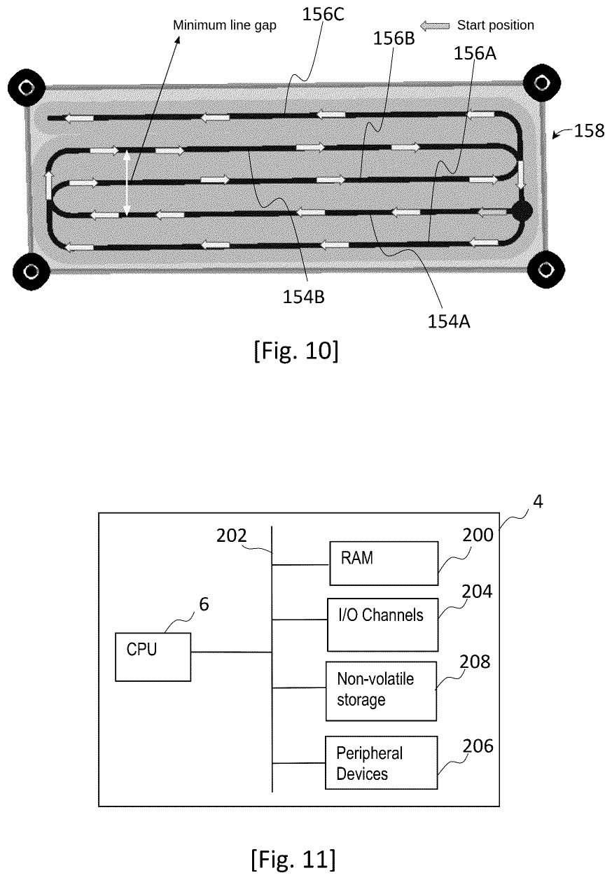

The split set of parallel lines are sorted individually based on the minimum number of line gaps l_min. Sorting sets the lines in order in which they need to be visited. Taking into consideration the turning radius r as the constraint, Dubins curve is applied to the sorted lines for generating the curved connection between them. This ensures that each pattern path obeys the robot's kinematic constraint of turning radius. What is achieved with this approach is illustrated in FIG. 10. FIG. 10 shows a first set of parallel lines 154A, 154B and a second set of parallel lines 156A, 156B, 156C that cover a rectangle 158. The robot will visit the first set of parallel lines 154A, 154B first by moving along a line 154A from right to left, make a right turn and go from left to right along line 154B. The robot then makes another right turn to visit the second set of parallel lines by going from right to left along line 156A, making a right turn and going from left to right along line 156B before making a left turn and completing the cleaning path by going from right to left along 156C. These lines 154A, 154B, 156A, 156B, 156C define a patten path 127 (FIG. 6C) of the rectangle 158. The first set of parallel lines and the second set of parallel lines are interlaced.

The generation of the candidate spiral path in the GENERATE CANDIDATE SPIRAL PATH step 122 is next described. The spiral path is generated based on the buffers or smaller polygons that were generated earlier in the FIND FITTING RECTANGLE step 114. Each smaller polygon 130 defines a loop in the spiral path 129 (FIG. 6C). Each loop is connected to an adjacent loop using a Dubins curve to satisfy the turning radius constraint of the robot. The connection between each spiral path is manipulated to be near the end of a pattern path.

In the GENERATE CANDIDATE SPIRAL PATH step 122, the number of loops is determined by the spiral limit, slimit, obtained in the FIND FITTING RECTANGLE step 114. However, in the GENERATE SPIRAL PATH step 160, the number of loops is set to a predetermined number, e.g. two loops although other numbers may be used. The final cleaning path is generated by connecting a spiral path to the end of a pattern path with an appropriate curve. The above-described process is carried out for all the sides of a rectangle and a polygon.

Computing of the cleaning cost of each cleaning path is next described. A heatmap is generated for every cleaning path that is generated for the given polygon regardless of whether a rectangle is found to fit within the polygon using any suitable image processing techniques. With the use of the heatmap, the cleaning cost is computed for each individual cleaning path generated. When a rectangle is obtained while computing the spiral limit, sₗᵢₘᵢₜ cleaning cost, C_{rect} is used. In the other case where no rectangle is obtained, a cleaning cost, C_{poly} is used.

$$\begin{matrix}\begin{matrix}{c}_{t} = {l}_{total} * 2 - 2 \\ {d}_{clean} = lenght ( {c}_{p} ) \\ {a}_{d} = {d}_{clean} * w \\ {a}_{poly} = area ( p ) \\ {p}_{e} = 100 - ( \frac{{a}_{poly} - {a}_{clean}}{{a}_{poly}} * 100 ) \\ {c}_{rect} = \frac{{a}_{d}}{{a}_{clean}} + 3 * ct \\ {c}_{poly} = \frac{{C}_{t}}{{P}_{c}}\end{matrix}\end{matrix}$$

where
Cₜ is the turns cost of the pattern path,
lₜₒₜₐₗ is the total number of lines in the pattern path,
d_{Clean} is the total cleaning distance,
Cₚ is the cleaning path,
length provides the length of the provided geometry item,
α_{d} is area of clean distance based on the cleaning width, w,
α_{poly} is the area of the given polygon, p,
area provides the area of the given geometry item,
P_{c} is the cleaning percentage,
α_{clean} is the cleaned area which obtained from the heatmap

The cleaning path that has the lowest cleaning cost will be the final cleaning path for the given polygon.

Accordingly, the processor of the robot described above is configured to obtain the floor plan 26 of the area 24, capture the first path 28 in the area 24 as the robot is guided by the user about the area 24, and display the captured first path 28 on the floor plan 26 on the display device. The processor is also configured to allow the user to modify the captured first path 28 on the display device to obtain a desired first path and automatically move along the desired first path during operation.

Accordingly, a method of deploying the robot to clean the area 24 by the user is also described. The method includes guiding the robot about the area to allow the robot to capture the first path 28 in the area 24 as the robot is guided by the user about the area 24, modifying the captured first path 28 to obtain a desired first path via a display, and deploying the robot to automatically move along the desired first path to clean the area 24.

FIG. 11 is a block diagram illustrating typical elements of the controller board 4 that may be appropriately programmed to execute the methods described above. The elements include the programmable processor 6 connected to a system memory 200 via a system bus 202. The processor 6 accesses the system memory 200 as well as other input/output (I/O) channels 204 and peripheral devices 206. The controller board 4 further includes at least one program storage device 208, such as a CD-ROM, tape, magnetic media, EPROM, EEPROM, ROM or the like. The controller board 4 stores one or more computer programs that implement the methods described above. The processor 6 reads and executes the one or more computer programs to perform the methods. Each of the computer programs may be implemented in any desired computer programming language (including machine, assembly, high level procedural, or object oriented programming languages). In any case, the language may be a compiled or interpreted language.

Advantageously, the method described above allows a user to easily configure and operate a cleaning robot, making the process less laborious and time consuming. The method allows a cleaning zone to be defined simply by having a user guide the robot along a path in the area. The captured path is stored and the user can edit the captured path to modify the path. A cleaning path within the cleaning zone is also automatically generated by a processor according to an algorithm that may ensure an optimum cleaning path.

Although the present invention is described as implemented in the above-described embodiments, it is not to be construed to be limited as such. It is to be appreciated that modifications and improvements may be made without departing from the scope of the present invention.

For example, although the robot is described as being guided by a user wheeling the robot around the area to be cleaned, the robot may be guided around in several other ways. The user may for example be on the robot and driving it around. The user may also be controlling the movement of the robot remotely. The robot may also be configured to detect and follow the user as the user moves around the area.

As another example, the captured path is described to be displayed on a display device on the robot. The captured path may alternatively or additionally be displayed on a device in data communication with the robot to allow a user to remotely modify the captured path that is stored on the robot.

As yet a further example, although the robot is described to be a cleaning robot, other robots may be used.

It should be further appreciated by the person skilled in the art that one or more of the above modifications or improvements, not being mutually exclusive, may be further combined to form yet further embodiments of the present invention.

What is claimed is:

1. A robot comprising:
a processor configured to:
obtain a floor plan of an area;
capture a first path in the area as the robot is guided by a user about the area;
display the captured first path on the floor plan on a display device;
allow the user to modify the captured first path on the display device to obtain a desired first path; and
automatically move along the desired first path during operation.

2. The robot according to claim 1, wherein the first path defines a perimeter of a cleaning zone within the area, and wherein the processor is further configured to:
generate a second path within the cleaning zone; and
automatically move along the second path during operation.

3. The robot according to claim 2, wherein the processor is configured to:
determine if a rectangle can be defined within the cleaning zone; and
obtain a pattern path for the rectangle and a spiral path around the rectangle that together define the second path if it is determined that a rectangle can be defined within the cleaning zone.

4. The robot according to claim 3, wherein the processor is configured to:
increasingly reduce a size of the cleaning zone, each time by a cleaning width of the robot to obtain a current smaller cleaning zone until the robot determines one of a rectangle and minimum rotated rectangle bounding the current smaller cleaning zone fits within the cleaning zone or no further smaller cleaning zone can be obtained.

5. The robot according to claim 3, wherein the processor is configured to:
generate a candidate pattern path from each side of the rectangle to obtain a plurality of candidate pattern paths in the rectangle;
generate a plurality of candidate spiral paths;
determine a cleaning cost for each combination of each of the plurality of candidate pattern paths and each of the plurality of candidate spiral paths; and
select a combination of candidate pattern path and candidate spiral path with a lowest cleaning cost as the second path.

6. The robot according to claim 1, wherein the processor is configured to:
provide points along the captured first path which can be moved to modify the captured first path.

7. The robot according to claim 6, wherein the processor is configured to:
allow the points to be dragged and dropped to modify the captured first path.

8. The robot according to claim 1, wherein the processor is configured to:
obtain the floor plan of the area and capture the first path at the same time.

9. The robot according to claim 8, further comprising:
a Lidar scanner; and
wherein the processor is configured to obtain the floor plan of the area using the Lidar scanner.

10. A method of operating a robot to clean an area, the method comprising:
obtaining a floor plan of the area;
capturing a first path in the area as the robot is guided by a user about the area;
displaying the captured first path on the floor plan;
allowing the user to modify the captured first path to obtain a desired first path; and
allowing the robot to be operated to automatically move along the desired path to clean the area.

11. The method according to claim 10, wherein the path defines a perimeter of a cleaning zone within the area, and wherein the method further comprises:
automatically generating a second path within the cleaning zone; and
allowing the robot to be operated to clean the area along the second path while automatically moving therealong.

12. The method according to claim 11, wherein automatically generating a second path within the cleaning zone comprises:
determining if a rectangle can be defined within the cleaning zone; and
obtaining a pattern path for the rectangle and a spiral path around the rectangle that together define the second path if it is determined that a rectangle can be defined within the cleaning zone.

13. The method according to claim 12, wherein determining if a rectangle can be defined within the cleaning zone comprises:
increasingly reducing a size of the cleaning zone, each time by a cleaning width of the robot to obtain a current smaller cleaning zone until it is determined that one of a rectangle and minimum rotated rectangle bounding the current smaller cleaning zone fits within the cleaning zone or no further smaller cleaning zone can be obtained.

14. The method according to claim 12, wherein obtaining a pattern path for the rectangle and a spiral path around the rectangle that together define the second path comprises:
generating a candidate pattern path from each side of the rectangle to define a plurality of candidate pattern paths in the rectangle;
generating a plurality of candidate spiral paths;
determining a cleaning cost for each combination of each of the plurality of candidate pattern paths and each of the plurality of candidate spiral paths; and
selecting a combination of candidate pattern path and candidate spiral path with a lowest cleaning cost as the second path.

15. The method according to claim 10, wherein allowing the user to modify the captured first path comprises:
providing points along the captured first path which can be moved to modify the captured first path.

16. The method according to claim 15, wherein providing points along the captured first path which can be moved to modify the captured first path comprises:
providing the points along the path which can be dragged and dropped to modify the captured first path.

17. The method according to claim 10, wherein obtaining the floor plan of the area is performed at the same time as capturing the first path.

18. A method of deploying a robot to clean an area by a user, the method comprising:
guiding the robot about the area to allow the robot to capture a first path in the area as the robot is guided by a user about the area;
modifying the captured first path to obtain a desired first path via a display; and
deploying the robot to automatically move along the desired first path to clean the area.
